(19) United States
(12) Patent Application Publication
(10) Pub. No.: US 2005/0122747 A1
(43) Pub. Date: Jun. 9, 2005

(54) Power supply system

(75) Inventor: Susanne Gaksch, Erlangen (DE)

Correspondence Address: HENRY M FEIEREISEN, LLC, 350 FIFTH AVENUE, SUITE 4714, NEW YORK, NY, 10118, US

(73) Assignee: SIEMENS AKTIENGESELLSCHAFT, Munchen (DE)

(21) Appl. No.: 10/999,373

(22) Filed: Nov. 30, 2004

(30) Foreign Application Priority Data
Dec. 3, 2003 (DE) 103 56 514.0

(51) Int. Cl. H02M 3/335

(52) U.S. Cl. 363/24

(57) ABSTRACT

An electric power supply system includes a rectifier with an input connected to a power line and a DC output connected to a DC/DC converter. Two buffer capacitors are connected across the input and output, respectively, of the DC/DC converter. The output of the rectifier includes a plurality of diodes. An electronically controllable switch is electrically connected in parallel with a corresponding diode of the rectifier. A controller receives an input signal from a phase voltage of the power line and provides control signals to the controllable switches. The DC/DC converter is constructed symmetrically. This configuration results in a more cost-effective power supply system with an improved energy balance.

### CROSS-REFERENCES TO RELATED APPLICATIONS

This application claims the priority of German Patent Application, Serial No. 103 56 514.0, filed Dec. 3, 2003, pursuant to 35 U.S.C. 119(a)-(d).

### BACKGROUND OF THE INVENTION

The present invention relates to a power supply system with a rectifier with an input connected to a power line and an output connected to a DC/DC converter, and more particularly to a power supply system that enables energy recovery from the DC side to the power line.

Nothing in the following discussion of the state of the art is to be construed as an admission of prior art.

Conventional power supply systems that power a load from a single-phase or three-phase power line can include a rectifier connected to a DC/DC converter that supplies DC current to the load. If the load has to be braked, i.e. kinetic energy of the load must be dissipated, a brake resistor is typically used that converts the kinetic energy into heat. One exemplary conventional power supply system is shown in FIG. 1 and includes on the power line side a rectifier 2 with an input connected to a three-phase power line U, V, W and a line choke 4. A DC/DC converter 6 is connected to an output of the rectifier 2. The power supply system also includes two buffer capacitors 8 and 10 that are electrically connected in parallel with a corresponding input and output of the DC/DC converter 6. A voltage U_{DCV} across the buffer capacitor 10 can be supplied to a load 12.

For example, the load 12 can be a motor receiving power from an inverter and intended for a roller drive of a transport system. The DC output voltage U_{DCV} for such drive is controlled to, for example, 48 V. The three-phase power line can have a phase voltage of 380 V. The rectifier 2, which is line-commutated, generates from the three-phase line voltage a DC voltage U_{DCN} with an amplitude of, for example, 540 V. The DC/DC converter, which can be a flyback converter or a flux converter, provides the controlled DC voltage U_{DCV} of 48 V for the load. The turns ratio of voltage transformer in the converter is selected so as to convert the DC voltage U_{DCN} of 540 V is into a DC voltage U_{DCV} of 48 V. An AC voltage with six times the line frequency is superimposed on the output voltage U_{DCN} of the rectifier 2. An electronically controllable switch located on the primary side of the DC/DC converter 6 includes a switching regulator, to which an actual value and a desired value of the output-side DC voltage U_{DCV} are supplied, and controls the output voltage U_{DCN} on the secondary side of the DC/DC converter 6. A power supply system of this type can produce from a single-phase or a three-phase line voltage a controlled DC voltage U_{DCV} with a freely selectable amplitude that can be significantly smaller than the amplitude of the three-phase or single-phase line voltage.

If the load 12 is a controlled drive, then the drive may need to be braked, whereby mechanical energy is fed back into the buffer capacitor 10 of the power supply system in form of electric energy, which raises the voltage across the buffer capacitor 10. FIG. 2 shows a power supply with a separate brake circuit 14 that prevents an overvoltage on the capacitor 10 and ensures a safe stop of the drive. The brake circuit 14 includes a brake controller 16, also referred to as brake chopper, and a brake resistor 18, which is electrically connected in parallel with the brake controller 16. This brake circuit 14 maintains the voltage across the capacitor 10 at a predetermined level by converting the energy supplied by the load 12 into heat in the brake resistor 18, which may require a large resistor and adequate, sometimes forced cooling. The location of the resistor 18 must also be selected so as not to impair the operation of the power supply system.

The brake circuit can be eliminated by recovering the mechanical energy as electric energy and returning the recovered electric energy to the power line, which requires a return path for the energy from the load to the supply line.

German Pat. No. DE 199 13 634 discloses two different approaches for returning electric energy from the DC-link circuit of a power line converter to a power line. In a first approach described therein, a self-commutated pulsed converter, also referred to as Active Front End, is used instead of a line-commutated rectifier. Line feedback is minimal with an Active Front End, and the output voltage can be controlled. However, a self-commutated converter or Active Front End is expensive and complex and is employed only if stringent requirements are imposed on line feedback and if the dissipated braking power is very high.

In the second approach described therein, electronically controllable switches are electrically connected in parallel with corresponding diodes in one-to-one correspondence, whereby the switches are controlled synchronously with the conducting phases of the corresponding diodes. Although the line-side converter is now capable of conducting electric current in both current directions, it is still of the line-commutated, free-running type which is expensive and complex. The conducting phases, which are determined by the inherent commutation times, are derived from the phase voltages of the power line.

However, even if the rectifier can conduct current in both directions, a brake circuit is still required with this conventional embodiment, because the DC/DC converter 6 is not configured to return electric energy from the load to the DC side of the rectifier.

It would therefore be desirable and advantageous to provide an improved power supply system to obviate prior art shortcomings and to eliminate the need for a brake circuit.

### SUMMARY OF THE INVENTION

According to one aspect of the present invention, an electric power supply system includes a rectifier provided with a plurality of diodes and having an input connected to a power line and a DC output, a DC/DC converter having a symmetric configuration and including an input, which is connected to the DC output of the rectifier, and an output, a first buffer capacitor electrically connected across the input of the DC/DC converter and a second buffer capacitor electrically connected across the output of the DC/DC converter, a plurality of electronically controllable switches which are electrically connected in parallel with the diodes of the rectifier in one-to-one correspondence, and a controller receiving an input signal from a phase voltage of the power line and providing control signals to the controllable switches.

As a consequence of the symmetric configuration of the DC/DC converter, the secondary side of the DC/DC converter is identical to the primary side, so that the converter is now configured for power feedback, making the entire power supply system capable of energy recovery. A brake circuit is therefore no longer required to dissipate energy from the load. Energy returned from the load to the power line significantly improves the energy balance of the power supply system. The power supply system of the invention is also significantly less expensive than a conventional power supply device with a brake circuit.

According to another feature of the present invention, the DC/DC converter can include a primary switching regulator and a secondary switching regulator, wherein an output of the primary (secondary) switching regulator is connected to a complementary control input of the secondary (primary) switching regulator with an isolated potential. An electronically controllable switch on the primary or secondary side is thereby turned on during the conducting phase of a corresponding diode to conduct electric current. This switch has a smaller forward voltage than the diode, which reduces the dissipated power and improves the efficiency.

According to another feature of the present invention, the DC/DC converter can be a flyback converter or a flux converter, and the primary and secondary switches of the DC/DC converter can be implemented as MOSFET's. The electronically controllable switches of the line-side rectifier can be implemented as insulated-gate-bipolar-transistors (IGBT).

The power supply system can be used as a central power feed for a decentralized drive system of, for example, a transport or conveyor system.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows schematically a circuit diagram of a prior art power supply device;

FIG. 2 shows schematically the prior art power supply device or FIG. 1 with a brake circuit;

FIG. 3 shows a first exemplary embodiment of a circuit diagram of a power supply device according to the present invention; and

FIG. 4 shows a second exemplary embodiment of a circuit diagram of a power supply device according to the present invention.

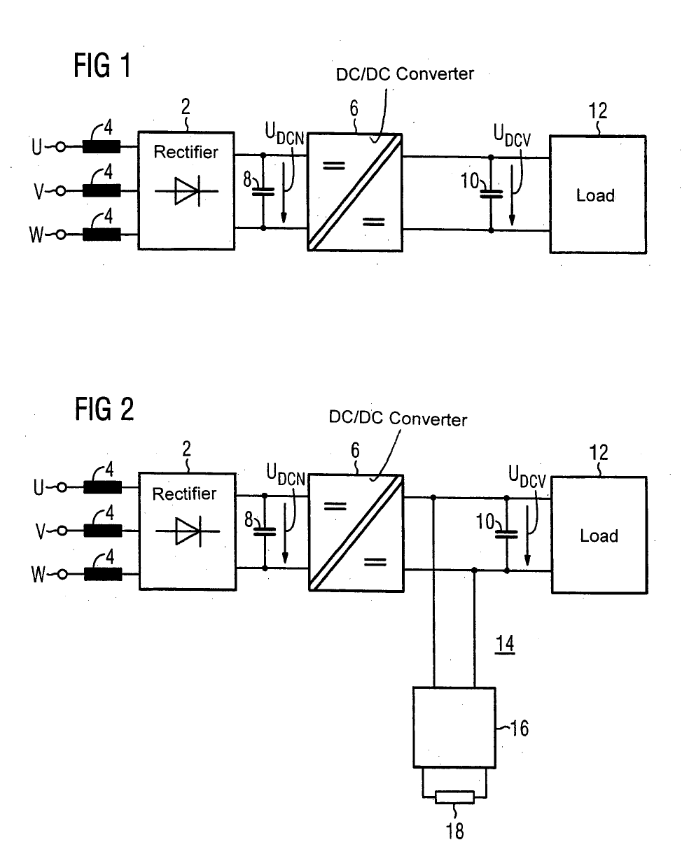

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

This is one of two applications both filed on the same day. Both applications deal with related inventions. They are commonly owned but have different inventive entity. Both applications are unique, but incorporate the other by reference. Accordingly, the following U.S. patent application is hereby expressly incorporated by reference: “DRIVE SYSTEM”.

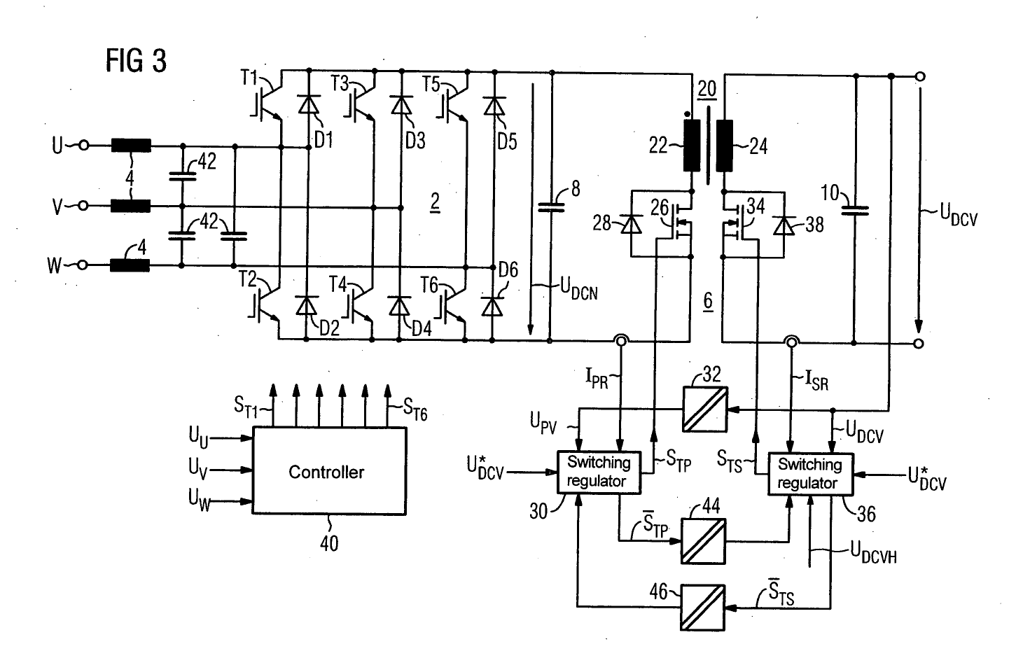

Turning now to the drawing, and in particular to FIG. 3, there is shown a first embodiment of a power supply device according to the present invention. The DC/DC converter 6 in this first embodiment is a flyback converter and includes a voltage transformer 20 with a primary winding 22 and a secondary winding 24. An electronically controllable switch 26 is connected on the primary side electrically in series with the primary winding 22. A buffer capacitor 8 is electrically connected in parallel with the series connection of switch 26 and winding 22. A reverse-biased diode 28 is connected in parallel with the electronically controllable switch 26, which receives control pulses from a switching regulator 30. The switching regulator 30 generates a control signal S_{TP} from a desired voltage value U*_{DCV} and an actual voltage value U_{DCV}, which is measured on the secondary side and transmitted to the primary side switching regulator 30 at a separate potential. The potential separation is implemented with an opto-coupler 32.

According to the invention, the DC/DC converter 6 should be configured symmetrically, so that the current flow in the secondary side is identical to the current flow in the primary side. Therefore, an electronically controllable switch 34 is connected electrically in series with the secondary winding 24 of the voltage converter 20. This series connection is likewise electrically connected in parallel with a buffer capacitor 10. The switch 34 is also controlled by a switching regulator 36. A reverse-biased diode 38 is likewise connected in parallel with the electronically controllable switch 34. The switching regulator 36 on the secondary side also requires a desired voltage value U*_{DCV} and an actual voltage value U_{DCV} for generating a control signal S_{TS} on the secondary side. With this arrangement according to the invention, the DC/DC converter 6 is now capable of energy recovery.

The line-side rectifier 2 in the exemplary embodiment is a three-phase rectifier having an input connected to a three-phase power line. For sake of clarity, only the terminals U, V, and W are shown. If the power supply device is to be connected to a single-phase power line, the rectifier 2 is implemented as an H-bridge. In the illustrated embodiment, the rectifier 2 includes diodes D1 to D6 as current valves, with each bridge arm including a pair of diodes. According to the invention, electronically controllable switches T1 to T6, which can be implemented, for example, as Insulated Gate Bipolar Transistors (IGBT), are connected antiparallel with the diodes D1 to D6 in one-to-one correspondence. The control input of each switch T1 to T6 is connected to a control output of a controller 40 that provides control signals S_{T1} to S_{T6} for controlling the electronically controllable switches T1 to T6 synchronously with the corresponding diodes D1 to D6. The controller 40 determines the conducting phases of the diodes D1 to D6, which are defined by the inherent commutation times (intersection between two phase voltage curves), from the phase voltages U_{U}, U_{V}, and U_{W} of the power line. The rectifier 12 designed for energy recovery includes, as also described in DE 199 13 634 C2, line-side capacitors 42, which are each connected between two phases of the line voltage to prevent voltage dips in the power line from exceeding a predetermined value.

By enabling the line-side rectifier 2 and the output-side DC/DC converter 6 to feed back dissipated energy, a power supply device with a significantly improved energy balance is obtained. This power supply device is also less expensive than a conventional power supply device with a brake circuit.

FIG. 3 shows two additional opto-couplers 44 and 46. Opto-coupler 44 transmits a control signal S*_{TP}, that is complimentary to the control signal S_{TS} for the electronically controllable switch 26 on the primary side, to the secondary-side switching regulator 36 at a separate potential. Opto-coupler 46 transmits a complimentary control signal S*_{TS}, that is complimentary to the control signal S_{TS} for the electronically controllable switch 34 on the secondary side, to the primary-side switching regulator 30 at a separate potential. The switch 34 on the secondary side and the switch 26 on the primary side are controlled by the respective complimentary control signals S*_{TP} and S*_{TS} in relation to the conducting phases of the corresponding diodes 38 and 28, respectively. In addition to the complimentary control signals S*_{TP} and S*_{TS}, information about the current direction in the secondary and primary current loops of the DC/DC converter 6 is also required for identifying the conducting phase of the diode 38 and 28, respectively. The primary and secondary current loops therefore include current measuring devices 45 and 47. The measured directional current signals I_{SR} and I_{PR} are supplied to the respective switching regulators 36 and 30. The electronically controllable switches 34 and 26, respectively, are also controlled by the signals S*_{TP} and I_{SR}, and S*_{TS} and I_{PR}, whereby the switches 34 and 26 become conducting in synchronism with the conducting phase of the corresponding diodes 38 and 28. Because the switches 26 and 34 have a smaller forward voltage than the diodes 28 and 38, the dissipated power is reduced and the efficiency improved.

The operation of the current supply device according to the invention will now be briefly described with reference to the afore-described embodiment:

The line-side rectifier 2 generates from a supply line voltage of, for example, 380 VAC a DC voltage U_{DCN} of approximately 540 VDC. The load 12 requires a DC voltage U_{DCV} of only, for example, 48 V. Therefore, a DC/DC converter 6 is connected downstream of the rectifier 2, whereby the voltage transformer 20 of the DC/DC converter 6 has a turns ratio T_{R} that generates from the primary voltage 540 V a secondary voltage of 48 V. The calculated turns ratio is 11.25. A turns ratio T_{R}=11 and a clock pulse ratio of 1:1 produces on the secondary side a voltage of U_{DCV}=49 V, whereas a turns ratio T_{R}=12 and a clock pulse ratio of 1:1 produces on the secondary side a voltage of U_{DCV}=45 V. In addition, the rectified voltage U_{DCN} across the buffer capacitor 8 has an AC component at a frequency six times the line frequency. The AC voltage of the power line is also not always constant and can vary within foreseeable limits. Accordingly, the voltage U_{DCV} supplied to the load across buffer capacitor 10 does not always have exactly the required voltage of 48 V. Therefore, the electronically controllable switch 26 with associated switching regulator 30 on the primary side controls the voltage U_{DCV} supplied to the load across buffer capacitor 10 to the predetermined desired value U*_{DCV}=48 V, based on a desired voltage U*_{DCV} and a actually measured voltage U_{DCV}. As long as the voltage U_{DCV} supplied to the load 12 is ≦48 V, the switching regulator 30, e.g. the commercially available switching regulator UC384X, controls the switch 26 on the primary side, so that energy flows from the power line via the rectifier 2 and the DC/DC converter 6 to the load 12.

If the load 12 is to be braked, i.e., the load 12 supplies electric energy to the output-side buffer capacitor 10 of the power supply device, then the voltage across the buffer capacitor 10 increases. If the applied voltage U_{DCV} exceeds the predetermined desired voltage value U*_{DCV} by a predetermined hysteresis value U_{DCVM}, then the switching regulator 36 on the secondary side generates a control signal S_{TS} that controls the switch 34 on the secondary side. The switching regulator 36 on the secondary side remains active until the load voltage U_{DCV} becomes smaller than U*_{DCV}+U_{DCVM}. Only the switching regulator 36 is controlled, because only the increasing load voltage U_{DCV} needs to be limited by the secondary-side switch 34 to recover the energy generated by the load 12. Because the line-side rectifier 2 is configured for recovering electric energy, the energy supplied by the load 12 is returned to the power line. A state signal indicating that energy is transmitted from the load 12 to the power line is not required, because the rectifier 2 it is able to conduct electric current in both directions.

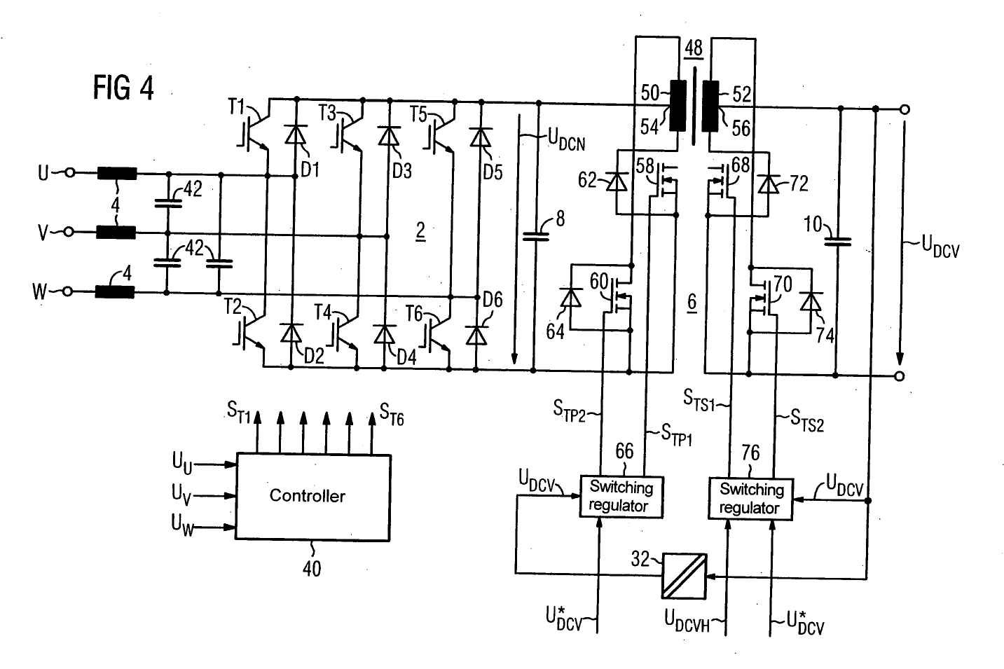

FIG. 4 shows schematically a second embodiment of the current supply device according to the invention. Unlike the first embodiment depicted in FIG. 3, where the DC/DC converter 6 is a flyback converter, the DC/DC converter 6 is implemented here as a flux converter and also includes a voltage transformer 48 which, unlike the voltage transformer 20 of FIG. 3, now has a primary winding 50 and a secondary winding 50 with respective center taps 54 and 56. A positive terminal of the buffer capacitor 8 is connected to the center tap 54 of the primary winding 50, whereby the center tap 54 forms an input terminal of the DC/DC converter 6. Each winding end of the primary winding 50 is connected to a negative terminal of the buffer capacitor 8 through a respective electronically controllable switch 58 and 60. A reverse-biased diode 62 and 64 is connected in parallel with a corresponding switch 58 and 60. The control inputs of the two electronically controllable switches 58 and 60 are connected with a switching regulator 66, which generates control signals S_{TP1} and S_{TP2} for the two switches 58 and 60, depending on a measured actual voltage U_{DCV} that represents the load voltage U_{DCV} and is transmitted at a separate potential, and a predetermined desired voltage U*_{DCV}. As can be seen, the described primary switching circuit corresponds to the primary switching circuit of a conventional flux converter.

Because the DC/DC converter 6 according to the invention should be configured symmetrically, the secondary switching circuit of this flux converter also includes two electronically controllable switches 68 and 17 and reverse-biased diodes 72 and 74. Each diode is connected antiparaliel with a corresponding switch 68 and 70. The center tap 56 of the secondary winding 52 forms an output terminal of the flux converter, whereby the connection point of the two electronically controllable switches 68 and 70 forms a second output terminal of the flux converter. The buffer capacitor 10 on the output side is connected to the two aforementioned output terminals, providing a controlled load voltage U_{DCV}. The control inputs of the two secondary switches 68 and 70 are connected to a switching regulator 76 that supplies at its output two control signals S_{TS1} and S_{TS2}. As in the embodiment of FIG. 3, a measured actual voltage value U_{DCV}, a predetermined desired voltage value U*_{DCV}, and a hysteresis value U_{DCVM} are supplied to the switching regulator 76 on the secondary side. This DC/DC converter 6 is operated in the same manner as the DC/DC converter 6 of the embodiment of FIG. 3.

A DC voltage regulated in this manner can be used, for example, as a central power supply for inverter-powered motors of a roller drive of a transport system. The number of the inverter-powered motors that can be connected in common to the regulated DC voltage depends on the required motor power. A rapid braking action may be required to position a transported item on a conveyor or to move a transported item from one conveyor to another within the shortest possible cycle time, while mechanical energy is recovered in the central power feed as electric energy. Because the motors of at least one roller drive module of the transport system must be operated with an identically controlled angle, the drives with the identically controlled angle have to be braked simultaneously. Stated differently, the energy to be recovered cannot be dissipated by the drives. The transport segments in modern transport systems made of separate roller drive modules are a very compact, which would disadvantageously be disrupted if a conventional brake circuit were employed.

By employing the power supply device of the invention as the central power supply for a decentralized drive for a transport system, a very compact transport system is obtained with modules (roller drive modules, electric power supply, regulators and controllers) that need only be connected mechanically and electrically. With the current supply device constructed according to the invention, a brake circuit requiring brake resistors is eliminated. Brake resistors are not only expensive, but also require ample space, which may either not be available or may be better used otherwise, in particular with modular transport systems. Moreover, a transport system with the current supply device according to the invention that centrally supplies decentralized inverter-powered motors has a cost advantage that can benefit the customer.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. An electric power supply system, comprising:
a rectifier having an input connected to a power line and a DC output, said rectifier comprising a plurality of diodes;
a DC/DC converter having a symmetric configuration and including an input, which is connected to the DC output of the rectifier, and an output;
a first buffer capacitor electrically connected across the input of the DC/DC converter and a second buffer capacitor electrically connected across the output of the DC/DC converter;
a plurality of electronically controllable switches which are electrically connected in parallel with the diodes of the rectifier in one-to-one correspondence; and
a controller receiving an input signal from a phase voltage of the power line and providing control signals to the controllable switches.

2. The power supply system of claim 1, wherein the DC/DC converter comprises a primary switching regulator and a secondary switching regulator, wherein an output of the primary switching regulator is connected with an isolated potential to a complementary control input of the secondary switching regulator, and an output of the secondary switching regulator is connected with an isolated potential to a complementary control input of the primary switching regulator.

3. The power supply system of claim 1, wherein the DC/DC converter is a flyback converter.

4. The power supply system of claim 1, wherein the DC/DC converter is a flux converter.

5. The power supply system of claim 1, wherein each of the primary and secondary switches of the DC/DC converter is constructed as MOSFET.

6. The power supply system of claim 1, wherein the electronically controllable switches of the line-side rectifier are implemented as insulated-gate-bipolar-transistors.

7. The power supply system of claim 1 for use as a central power feed of a decentralized drive system of a transport system.
